(19) United States
(12) Patent Application Publication
(10) Pub. No.: US 2004/0083197 A1
(43) Pub. Date: Apr. 29, 2004

(54) Database management method and system

(75) Inventors: Morihiro Iwata, Tama (JP); Yoshitaka Tokusho, Tokyo (JP); Kentaro Chigusa, Yokohama (JP)

Correspondence Address: Hogan & Hartson, Biltmore Tower, Suite 1900, 500 South Grand Avenue, Los Angeles, CA, 90071, US

(73) Assignee: Hitachi, Ltd.

(21) Appl. No.: 10/424,882

(22) Filed: Apr. 28, 2003

(30) Foreign Application Priority Data
Oct. 25, 2002 (JP) 2002-311406

(51) Int. Cl. G06F 7/00

(52) U.S. Cl. 707/1

(57) ABSTRACT

A database management system that performs a first internal database operational management according to instruction information concerning the first database operational management. When a second database operational management additionally is performed by the database management system according to instruction information given from outside concerning the second database operational management, the database management system extracts information that includes a time range scheduled for executing the second database operational management. The database management system also extracts, from the first instruction information concerning the internal database operational management, operational management schedule information including a time range scheduled and a time range changeable for executing the first database operational management that is scheduled to be executed within the time range scheduled for executing the second database operational management, and determines, based on the operational management schedule information extracted, whether the time range scheduled for executing the first database operational management can be shifted outside the time range scheduled for executing the second database operational management.

### BACKGROUND OF THE INVENTION

1. Field of the Invention

The present invention relates to a database management method and system, and more particularly to a database management method and system that perform operational management of databases based on instructions from applications.

2. Related Background Art

Conventionally, database management systems (DBMS) have been used to provide efficient storage and search methods and highly reliable data management method for large volumes of data, such as library information, patent information and document information used in corporations (hereinafter called the “first usage mode” of DBMS). In the first usage mode, one or more applications that use stored data are constructed to utilize the stored data, and the first usage mode requires database operational management work, such as data backup and reorganization, in order to improve the reliability of the database and to maintain efficient searches and storage. In this type of usage mode of DBMS, the focus is generally on data, and database operational management work such as data backup and reorganization is done on the data from outside. In other words, the database operational management work in this case involves directly executing utility commands and/or tools for database operational management that the DBMS has.

See An Introduction to Database Systems, 7th Edition by C. J. Date, Addison Wesley Longman, Inc., 2000 (document 1), for example, for configurations concerning directly executing database operational management work from outside using utility.

However, if there is only one application, besides the method of directly executing commands and/or tools for database operational management, another method is to give instructions for database operational management from outside through the application, such that commands and/or tools for database operational management are called through the application using database operational management API.

See Microsoft SQL Server 2000 Administrator's Companion by Marcilina S. Garcia, et al., Microsoft Press, 2000 (document 2) for the method to call database operational management API from an application.

There is a different usage mode for database management systems (hereinafter called the “second usage mode”) in contrast to the first usage mode. The second usage mode is used to manage data that an application uses internally. In this type of usage mode for database management system, the focus is on the application. Application users want to use the application and do not want to be bothered with database operational management such as data backup and reorganization. For this reason, with regard to database operational management work for data that an application uses internally, an application developer creates instruction information that includes when to perform database operational management (hereinafter called the “database operational management instruction information”) in advance in consideration of execution time for individual operational management such as backup and reorganization; individual database operational management work takes place automatically within the DBMS based on the database operational management instruction information, thereby reducing the time and work application users invest in database operational management. In this case, when the application is executed, database operational management work takes place internally based on instructions of the database operational management information without the application users being aware of it.

The method for internally executing database operational management work in this way is described in document 2.

However, some applications use two or more types of data that correspond to both the first usage mode and the second usage mode and manage databases with a database management system. In this case, on one hand, database operational management work takes place internally without the application user being aware of it, based on the policy of operational management according to the second usage mode. On the other hand, the application user directly and with awareness performs database operational management work from outside by executing, either directly or through the application, commands and/or tools for database operational management, based on the policy of operational management through application user according to the first usage mode.

In conventional systems that use two or more types of data that correspond to both the first usage mode and the second usage mode and that manage databases with a database management system, when a database operational management work according to the second usage mode is already taking place internally and an application user attempts to perform a database operational management work according to the first usage mode in addition, there is a possibility of a conflict between the two works, due to such reasons as the works cannot be executed simultaneously or the execution of the works interacts, causes the integrity of the database to fail, and leads to an error. As a result, the application user is unaware of what is taking place inside the DBMS as database operational management work according to the second usage mode, and when an error occurs for reasons that he or she does not understand, the application user cannot perform the database operational management work according to the first usage mode even if the application user wanted to.

In some applications that use DBMS for data management, database operational management work automatically takes place internally (i.e., the second usage mode); when an additional database operational management work is to be performed from outside with awareness according to a different database operational management policy (i.e., the first usage mode), the database operational management work from outside must be performed taking care not to cause any conflicts. However, database operational manage work that automatically takes place internally is not discernible to an application user who wants to perform database operational management work from outside with awareness. As a result, the prior art cannot allow database operational management work from outside with awareness to take place while taking into consideration the database operational management work that automatically takes place internally.

In addition to the first usage mode and the second usage mode, similar problems generally arise in applications that use DBMS to manage data used when a database operational management is already taking place internally according to operational management instructions based on a certain database operational management policy and an attempt is made to perform an additional database operational management from outside according to a different database operational management policy.

For example, in different usage modes of DBMS, a plurality of operational management instructions for database operational management performed internally may be operated. One such example is a situation in which one DBMS is shared to manage data used internally by a plurality of applications, and there is a high possibility that a plurality of operational management instructions is created according to a different database operational management policy for each application. In such a case, until they are operated, operational management instructions for applications that are executed later can be considered equivalent to a plurality of database operational managements that are performed additionally from outside, which would lead to problems similar to those described above.

### SUMMARY OF THE INVENTION

The present invention relates to a database management method and system that can solve the problems entailed in the prior art and avoid conflicts between operational management works in applications that use DBMS to manage data, when a first database operational management is taking place internally according to operational management instructions based on a certain database operational management policy and a second database operational management is to be performed additionally from outside based on a different database operational management policy.

In accordance with an embodiment of the present invention, a database operational management method for a database management system that performs a first database operational management according to instruction information concerning the first database operational management, when performing a second database operational management additionally is performed, includes the steps of accepting instruction information concerning the second database operational management; extracting information that includes a time range scheduled for executing the second database operational management; extracting, from the instruction information concerning the first database operational management, operational management schedule information including the time range scheduled, as well as the time range changeable to, for executing the first database operational management that is scheduled to be executed within the time range scheduled for executing the second database operational management; and determining, based on the operational management schedule information extracted from the instruction information concerning the first database operational management, whether the time range scheduled for executing the first database operational management can be shifted outside the time range scheduled for executing the second database operational management.

Furthermore, in accordance with an embodiment of the present invention, a database management system, which performs a first database operational management according to instruction information concerning the first database operational management, is equipped with an operational management acceptance processing section that accepts information for a second database operational management instruction and extracts the time range scheduled for executing the second database operational management; an operational management schedule information extraction processing section that extracts, from the instruction information concerning the first database operational management, operational management schedule information that includes the time range scheduled, as well as the time range changeable to, for executing the first database operational management; an operational management time range shift determination processing section that, based on the operational management schedule information extracted from the instruction information concerning the first database operational management, determines whether the time range scheduled for executing the first database operational management can be shifted outside the time range scheduled for executing the second database operational management; and an operational management time range change processing section that, when there is a first database operational management scheduled to be executed in the time range the second database operational management is scheduled to be executed and the time range scheduled for executing the first database operational management can be shifted outside the time range scheduled for executing the second database operational management, changes the time range scheduled for executing the first database operational management to outside the time range scheduled for executing the second database operational management, and when there is a first database operational management scheduled to be executed in the time range the second database operational management is scheduled to be executed and the time range scheduled for executing the first database operational management cannot be shifted outside the time range scheduled for executing the second database operational management, notifies as output information in response to the instruction information concerning the second database operational management to change the time range scheduled for executing the second database operational management.

With the composition described above, the present invention informs an appropriate time to execute the second database operational management from outside even if one does not know the content of the first database operational management taking place internally. By setting the API to execute the database operational management again in the time range notified as the output information, not only would one be informed of an appropriate time to execute the database operational management, but a mechanism to execute the database operational management at the appropriate time can be added within the scope of the prior art. Through this, the present invention allows one to avoid conflicts when a database operational management is taking place internally and one attempts to perform a database operational management additionally from outside.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is an overview of the system configuration to illustrate the principle of a database operational management method in accordance with an embodiment of the present invention.

FIG. 2 is a block diagram of the system configuration of a database management system in accordance with one embodiment of the present invention.

FIG. 3 is a flowchart illustrating the overall processing operations in accordance with an embodiment of the present invention.

FIG. 4 is an example of operational management schedule information extracted from a database operational management instruction from outside.

FIG. 5 is an example of operational management instruction internal information for internal database operational management.

FIG. 6 is an example of time range shift information 311 created in the processing that takes place in a step described in FIG. 3.

FIG. 7 is a flowchart illustrating the processing operations of an operational management acceptance processing section in a step described in FIG. 3.

FIG. 8 is a flowchart illustrating the processing operations of an operational management time range shift determination processing section in a step described in FIG. 3.

FIG. 9 is a flowchart illustrating the processing operations of an operational management time range change processing section in a step described in FIG. 3.

FIG. 10 is a block diagram of the system configuration of a database management system in accordance with a second embodiment of the present invention.

### DESCRIPTION OF THE PREFERRED EMBODIMENTS

Database operational management method and system in accordance with preferred embodiments of the present invention will be described below with reference to the accompanying drawings.

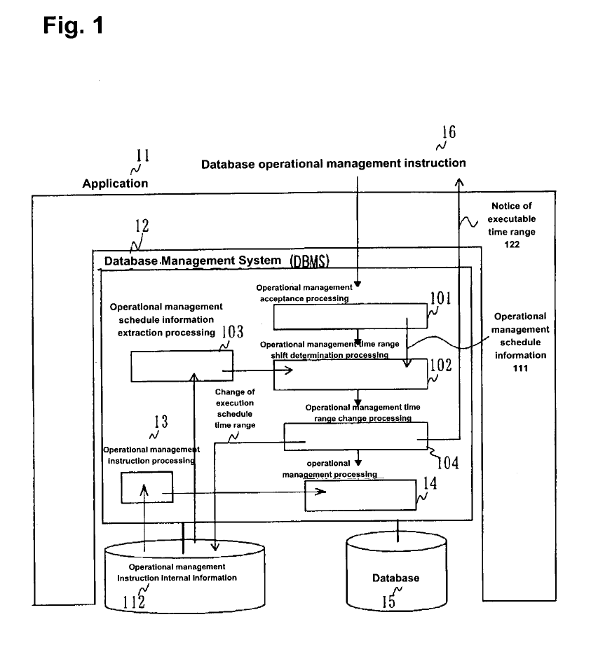

FIG. 1 is an overview of the system configuration to illustrate the principle of a database operational management method in accordance with an embodiment of the present invention.

The system shown in FIG. 1 comprises an application 11 that manages data using a database management system (DBMS), a DBMS 12 and a database 15. The DBMS 12, upon receiving operational management instruction internal information 112 that instructs a first database operational management that takes place internally, executes an operational management that takes place internally based on an instruction from an operational management instruction processing section 13 to an operational management processing section 14. The first operational management that takes place internally is within the scope of prior art.

When a second database operational management is to be performed additionally based on a database operational management instruction 16 from outside while the first database operational management is taking place internally based on the operational management instruction internal information 112 concerning database operational management that takes place internally, the application 11 that uses the DBMS 12 to manage data utilizes a mechanism that executes the two database operational managements at appropriate times to avoid conflicts between the first and second database operational managements.

To achieve this, the DBMS 12 according to the present invention is provided with an operational management acceptance processing section 101, an operational management time range shift determination processing section 102, an operational management schedule information extraction processing section 103 and an operational management time range change processing section 104.

Let us assume that the database operational management that is performed internally is taking place based upon an instruction in the operational management instruction internal information 112 that is given from the operational management instruction processing section 13 to the operational management processing section 14, and in the meantime information in the database operational management instruction 16 is provided from outside.

When this happens, first, the operational management acceptance processing section 101 accepts information in the database operational management instruction 16 from outside the DBMS 12 and extracts operational management schedule information 111, which includes a time range scheduled for executing a database operational management from outside (hereinafter called “the execution schedule time range”). Among methods to extract execution schedule time range are a method to directly provide the information from information contained in the database operational management instruction 16 from outside, a method to extract the information from statistical information concerning database operational management, and a method to set default values depending on the type of database operational management, but any method that determines the information uniquely based on the information in the database operational management instruction 16 may be used.

Next, whether the execution schedule time range of the database operational management that is performed internally based on the operational management instruction internal information 112 for the database operational management that takes place internally conflicts with the execution schedule time range of the database operational management from outside is checked. To do this, the operational management schedule information extraction processing section 103 analyzes the operational management instruction internal information 112 of the database operational management that takes place internally and extracts information concerning operational management schedule that includes the following information with regard to database operational management that takes place internally and that has a possibility of being executed within the execution schedule time range of the database operational management from outside:

the time range scheduled for internally executing the database operational management;

whether the execution schedule time range can be changed; and

the time range changeable to (if the execution schedule time range can be changed).

Among methods to extract the information are a method to directly provide the information from the operational management instruction internal information 112 for the database operational management that takes place internally, a method to extract the information from statistical information concerning database operational management, and a method to set default values depending on the type of database operational management, but any method that determines the information uniquely based on the operational management instruction internal information 112 for the operational management that takes place internally may be used.

If the execution schedule time range of the second database operational management based on the database operational management instruction 16 from outside begins with the present, while the time range scheduled for internally executing the database operational management includes the present, i.e., if the internal database operational management is being executed, the operational management time range shift determination processing section 102 determines that the execution schedule time range of the internal database operational management cannot be changed.

The operational management time range change processing section 104 determines the nature and database status integrity of the internal database operational management that would allow it to be executed simultaneously with an additional database operational management from outside, where the internal database operational management based on the operational management instruction internal information 112 has a possibility of being executed within the execution schedule time range of the database operational management based on the database operational management instruction 16 from outside; and if the operational management time range change processing section 104 determines that an error would result, it considers it a possible conflict and adjusts the time to execute one of the database operational managements.

In other words, if the execution schedule time range of the internal database operational management can be shifted to a time that will not cause any conflict with the additional database operational management provided from outside based on whether it is possible to change the execution schedule time range, and the time range it can be changed to, of the internal database operational management according to the operational management instruction internal information 112 that has a possibility of being executed within the execution schedule time range of the database operational management based on the database operational management instruction 16 from outside, the additional database operational management based on the database operational management instruction 16 from outside can be executed by the operational management processing section 14 in the original execution schedule time range. Accordingly, the execution schedule time range of the internal database operational management must be shifted in order to avoid any conflict, and the operational management time range change processing section 104 instructs a change of execution schedule time range 121 to the operational management instruction internal information 112 for the internal database operational management.

On the other hand, if there is an execution schedule time range of the internal database operational management that cannot be shifted to a time that will not cause any conflict with the additional database operational management from outside based on whether it is possible to change the execution schedule time range, and the time range it can be changed to, of the internal database operational management based on the operational management instruction internal information 112 that has a possibility of being executed within the execution schedule time range of the database operational management based on the database operational management instruction 16 from outside, the original execution schedule time range of the additional database operational management based on the database operational management instruction 16 from outside must be changed. Accordingly, the operational management time range change processing section 104 issues a notice of executable time range 122 as new output information to the outside.

Based on the above, a system operator can find an appropriate time to perform the database operational management based on the database operational management instruction 16 from outside even if he or she is unaware of the content of the operational management instruction internal information 112 for the database operational management that is performed internally. Further, by setting the application 11 to perform the database operational management within the time range designated in the notice of executable time range 122 that was issued as output information, database operational management can be performed from outside at an appropriate time.

Based on the principle described, an operator who performs a database operational management from outside would not only be informed of an appropriate time to perform the database operational management, but he or she would also be able to execute the database operational management at an appropriate time. Such a mechanism can be added within the scope of prior art, and it can be utilized to perform a database operational management while avoiding conflicts between database operational managements when one database operational management is taking place internally and an attempt is made to perform an additional database operational management from outside.

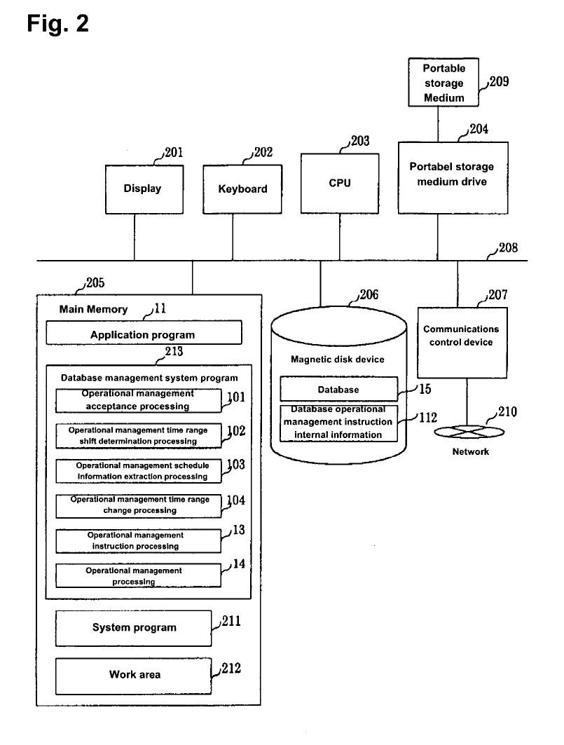

FIG. 2 is a block diagram of the system configuration of a database management system in accordance with one embodiment of the present invention. In FIG. 2, the management system includes a display 201, a keyboard 202, a central processing unit (CPU) 203, a storage medium drive 204, a main memory 205, a magnetic disk device 206, a communications control device 207, a system bus 208, a storage medium 209 such as a portable storage medium, a network 210, a system program 211, a work area 212, and a database management system program 213; other elements are identical to elements in FIG. 1 with the same numbers.

The database management system according to one embodiment of the present invention includes the display 201, the keyboard 202, the CPU 203, the storage medium drive 204 such as a portable storage medium drive including an FD drive, the main memory 205, the magnetic disk device 206 and the communications control device 207. This configuration is equivalent to the configuration of a general computer system, and no special hardware devices are required for the present invention. The display 201 is used to display execution status of the database management system (program), and the keyboard 202 is used to input commands to instruct the execution of the database management system.

The CPU 203 executes various programs that constitute the database management system, including programs to execute the present invention. The storage medium drive 204 is used to read and write data to and from the storage medium 209, such as, a portable storage medium including a flexible disk, an optical magnetic disk, or a write-once-read-many optical disk. The storage medium 209 may be a rewritable storage media or a read only storage media. The main memory 205 is used to retain temporary data that accompany various programs, including programs to execute the present invention, and execution of the programs. The magnetic disk device 206 is used to store the database 15 and the operational management instruction internal information 112 for database operational management. The communications control device 207 is used in the database management system to communicate, e.g., make requests and exchange data, via the network 210 with other database servers that have similar configurations. The system bus 208 is used to mutually connect various devices.

Inside the main memory 205 are retained the system program 211, the work area 212, and the database management system program 213, which comprises the database management system 12. The system program 211 provides basic functions, such as input and output of data to and from peripheral devices, to execute various programs that comprise the database management system, including programs to execute the present invention. The work area 212 is used to store data that are temporarily required to execute programs. The database management system program 213 is a general database management system with the operational management processing section 14, which performs backup and reorganization, and with the operational management instruction processing section 13, which automatically performs database operational management work inside the DBMS based on the operational management instruction internal information 112 that sets forth the time and conditions for performing database operational management.

The operational management acceptance processing section 101, the operational management time range shift determination processing section 102, the operational management schedule information extraction processing section 103 and the operational management time range change processing section 104, which perform processing that characterizes the database management method according to the present embodiment of the present invention, are in the database management system program 213. All programs including programs to execute the present embodiment of the present invention are stored in the main memory 205, which may be supplied via the network 210 or in the portable storage medium 209.

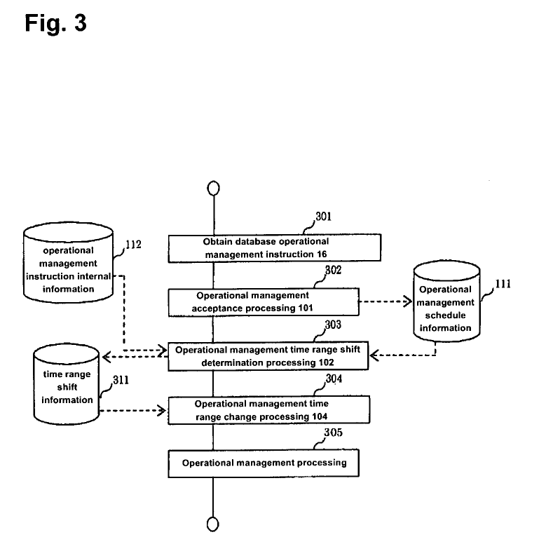

FIG. 3 is a flowchart illustrating the overall processing operation according to one embodiment of the present invention, as follows:

(1) First, the database operational management instruction 16 concerning a database operational management from outside the DBMS 12 is obtained. The database operational management instruction 16 for the database operational management obtained from outside is information that contains options information regarding operational management, such as the type of database operational management, and can be conventional operational management command or tool, or API (step 301).

(2) Next, the operational management acceptance processing section 101 in accordance with the present invention analyzes the database operational management instruction 16 for the database operational management obtained from outside the DBMS 12 and extracts the operational management schedule information 111, which contains the time range scheduled for executing the database operational management (hereinafter called “the execution schedule time range”) (step 302).

(3) Next, the operational management time range shift determination processing section 102 in accordance with the present invention checks whether execution schedule time range of the database operational management according to the database operational management instruction 16 obtained from outside conflicts with a database operational management that takes place internally based on the operational management instruction internal information 112. If there is a conflict, the operational management time range shift determination processing section 102 creates time range shift information 311 that includes information concerning shifting the execution schedule time range of one of the database operational managements (step 303).

(4) Next, the operational management time range change processing section 104 in accordance with the present invention performs a notifying processing of the change of execution schedule time range 121 to the operational management instruction internal information 112 if the time range shift information 311 indicates that the execution schedule time range needs to be shifted for the internal database operational management; and the operational management time range change processing section 104 performs a change processing of the notice of executable time range 122 to the database operational management instruction 16 from outside, if the time range shift information 311 indicates that the execution schedule time range needs to be shifted for the database operational management from outside (step 304).

(5) If the time range shift information 311 indicates that there is no need to shift the execution schedule time range of the database operational management from outside the DBMS 12, the operational management processing section 14 executes the database operational management within the original execution schedule time range (step 305).

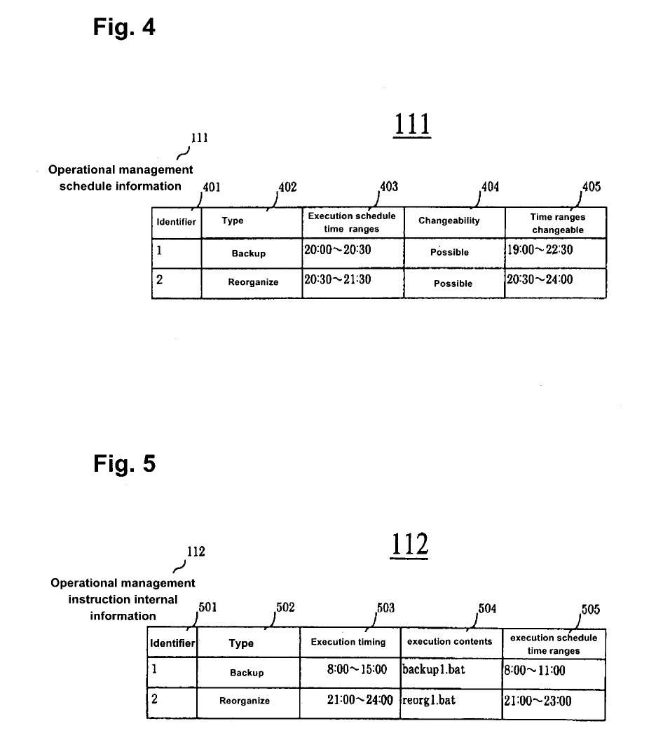

FIG. 4 is an example of the operational management schedule information 111 extracted from the database operational management instruction 16 from outside.

The operational management schedule information 111 includes such information as database operational management identifiers 401, types 402, execution schedule time ranges 403 for database operational management, changeability of the execution schedule time range 404, and time ranges changeable to (if the execution schedule time range can be changed) 405. As long as such information is available for each database operational management, the operational management schedule information 111 may be described in ways other than as indicated in FIG. 4 and/or may contain information other than those described.

Among methods to extract such information are a method to directly provide the information from information in the database operational management instruction 16, a method to extract the information from statistical information concerning database operational management, and a method to set default values depending on the database operational management type 402, but any method that determines the information uniquely based on the information in the database operational management instruction 16 may be used.

FIG. 5 is an example of the operational management instruction internal information 112 for internal database operational management.

The operational management instruction internal information 112 includes the time and conditions for performing database operational management as set forth in advance by an application developer based on his or her contemplating the application's operational management policy, and it includes such information as database operational management identifiers 501, types 502, execution timing (including time ranges) 503 for database operational management, execution contents (described by operational management command or batch file names) 504 of database operational management, and execution schedule time ranges 505 for database operational management.

The execution timing 503 for database operational management can include a description of conditions for performing database operational management in addition to the time range. In this case, the present invention can be applied by setting the time range at 24 hours or estimating the time when the conditions can be met.

Among methods to extract the execution schedule time range 505 for database operational management are a method to directly provide the information from the operational management instruction internal information 112, a method to extract the information from statistical information concerning database operational management, and a method to set default values depending on the database operational management type 502, but any method that determines the information uniquely may be used. Further, as long as such information is available for each database operational management, the operational management instruction internal information 112 may be described in ways other than as indicated in FIG. 5 and/or may contain information other than those described.

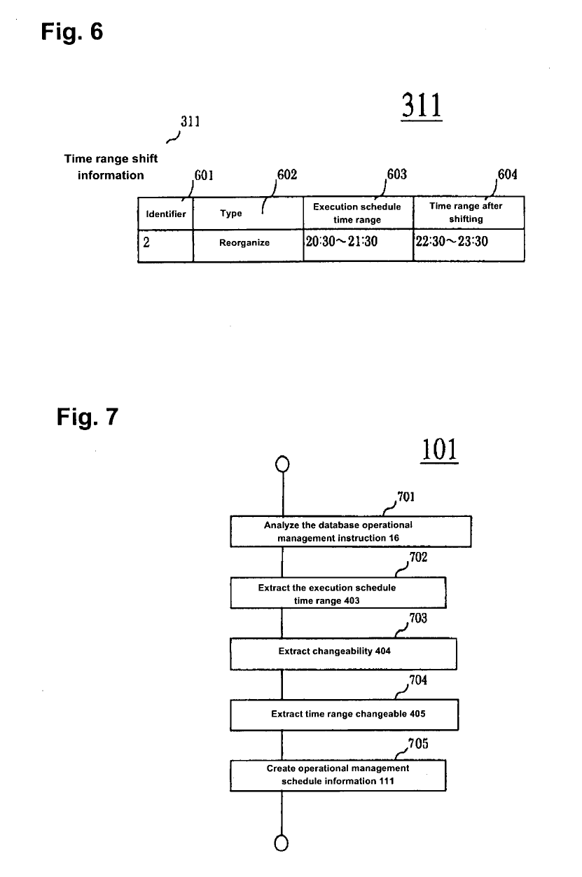

FIG. 6 is an example of the time range shift information 311 created in the processing that takes place in step 303 described in FIG. 3.

The time range shift information 311 includes an identifier 601 of a database operational management whose time range must be shifted, its type 602, an execution schedule time range 603 and a time range after shifting 604. The example shown in FIG. 6 applies to a situation in which the database operational management identifier 2 scheduled from outside in FIG. 4 has a conflict in its time range and must be shifted. The time range after shifting 604 is a range that is within the time range changeable to 405 of the operational management schedule information 111.

FIG. 7 is a flowchart illustrating processing operations of the operational management acceptance processing section 101 in step 302 in FIG. 3, as follows:

(1) The operational management acceptance processing section 101 first analyzes the database operational management instruction 16 and extracts information, such as the type of the database operational management, required for the execution of database operational management (step 701).

(2) Next, the operational management acceptance processing section 101 extracts the execution schedule time range 403, the changeability 404 and the time range changeable to 405, which would constitute the operational management schedule information 111 (steps 702-704).

(3) Next, the operational management acceptance processing section 101 creates the operational management schedule information 111 based on the information extracted in the processing that took place in steps 702-704 (step 705).

Among methods to extract such information are a method to directly provide the information from information in the database operational management instruction 16, a method to extract the information from statistical information concerning database operational management, and a method to set default values depending on the database operational management type, but any method that determines the information uniquely based on the information in the database operational management instruction 16 may be used.

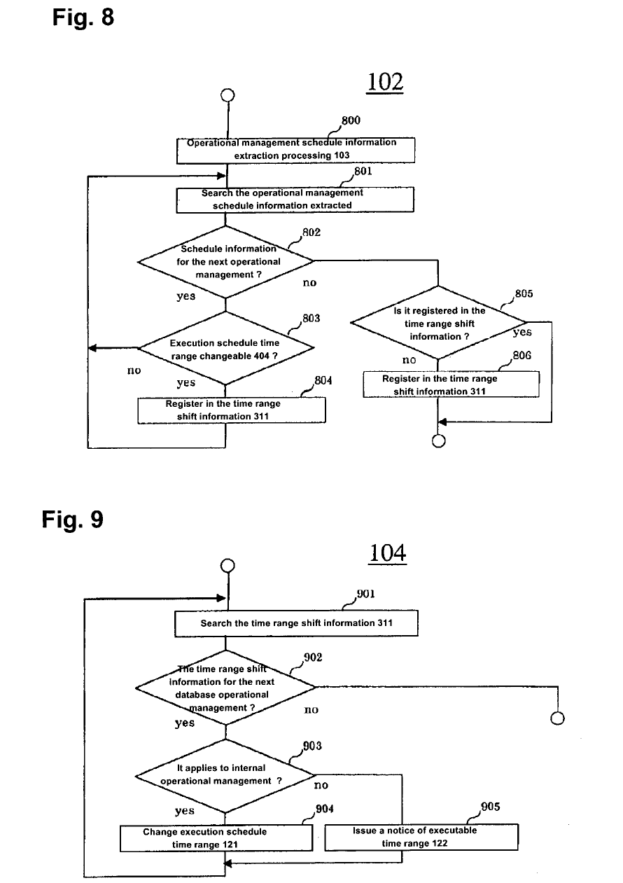

FIG. 8 is a flowchart illustrating processing operations of the operational management time range shift determination processing section 102 in step 303 described in FIG. 3, as follows:

(1) First, the operational management schedule information extraction processing section 103, which is provided for the present invention, extracts operational management schedule information from the operational management instruction internal information 112 for internal database operational management (step 800).

(2) Next, the operational management time range shift determination processing section 102 searches the operational management schedule information extracted by the operational management schedule information extraction processing section 103 to determine whether there is schedule information for the next operational management (steps 801 and 802).

(3) If it is determined in step 802 that there is schedule information for the next operational management, since there is a possibility that the next operational management would conflict with a database operational management instruction from outside, whether the execution schedule time range in the operational management schedule information 111 for a database operational management from outside can be changed is determined (step 803).

(4) If it is determined in step 803 that the execution schedule time range of the database operational management from outside can be changed, the change is registered in the time range shift information 311; if it is determined that the execution schedule time range cannot be changed, no processing takes place and the processing returns to step 803 to continue to check all operational management schedule information that may conflict with the database operational management from outside (step 804).

(5) If it is determined in step 802 that there is no schedule information for the next operational management, since the original execution schedule time range must be changed for the additional database operational management from outside based on the database operational management instruction 16, whether the database operational management from outside is registered in the time range shift information 311 is checked; if it is not registered, it is registered in the time range shift information 311 (steps 805 and 806).

FIG. 9 is a flowchart to illustrate processing operations of the operational management time range change processing section 104 in step 304 described in FIG. 3, as follows:

(1) The operational management time range change processing section 104, which is provided for the present invention, first searches the time range shift information 311 extracted by the operational management time range shift determination processing section 102 to determine whether there is the time range shift information 311 for the next database operational management (steps 901 and 902).

(2) If it is determined in step 902 that there is the time range shift information 311 for the next database operational management, whether the time range shift information 311 applies to an internal operational management is determined; if the time range shift information 311 applies to an internal operational management, the change of execution schedule time range 121 that changes the execution schedule time range 505 of the operational management instruction internal information 112 is issued, and the processing is repeated from step 901 (steps 903 and 904).

(3) If it is determined in step 903 that the time range shift information 311 does not apply to an internal operational management, since the original execution schedule time range of the additional database operational management from outside based on the database operational management instruction 16 must be changed, the notice of executable time range 122 is issued as output information, and the processing is repeated from step 901 (step 905).

The processing in the present embodiment according to the present invention as described is executed by various programs that comprise the operational management acceptance processing section 101, the operational management time range shift determination processing section 102, the operational management schedule information extraction processing section 103, and the operational management time range change processing section 104, all of which are in the database management system 12 in FIG. 2. However, such programs are not limited to those that are stored in external storage devices that are physically and directly connected to a computer system as indicated in the example in FIG. 2, and can be stored in storage media that a computer can read and write to and from, such as portable storage media, e.g., magnetic disk devices, flexible disks, optical magnetic disks and write-once-read-many optical disks.

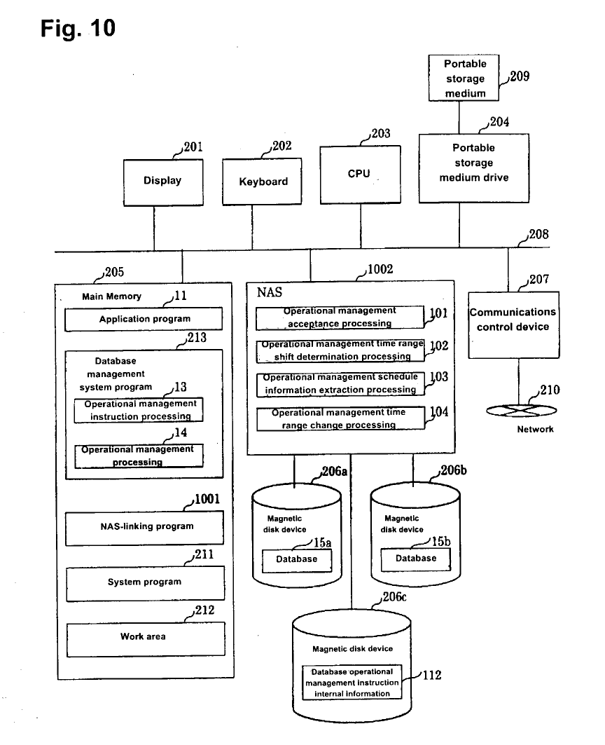

FIG. 10 is a block diagram of the system configuration of a database management system in accordance with a second embodiment of the present invention. The present invention can be applied to systems that use NAS (network attached storage), and the second embodiment of the present invention shown in FIG. 10 is an example of such a system. In FIG. 10, the management system includes a NAS-linking program 1001, a NAS 1002, magnetic disk devices 206a-206c and databases 15a and 15b; other elements are identical to those in FIG. 2 with the same numbers.

In the second embodiment of the present invention, the database 15 in FIG. 2 is divided into the databases 15a and 15b, and the databases 15a and 15b and database operational management instruction information 112 are stored divided among a plurality of magnetic disk devices 206a-206c that are managed by the NAS 1002. An operational management acceptance processing section 101, an operational management time range shift determination processing section 102, an operational management schedule information extraction processing section 103 and an operational management time range change processing section 104 are provided within the NAS 1002. The processing performed by these processing sections to avoid any conflict among a plurality of database operational managements takes place inside the NAS 1002. To do this, the NAS-linking program 1001 that links with the NAS 1002 is required, and the NAS-linking program 1001 is stored in a main memory 205.

The processing operations according to the second embodiment of the present invention having the configuration as described are the same as those described in FIGS. 3 through 9. The present invention is similarly applicable to configurations in which the processing by an operational management instruction processing section 13 and/or an operational management processing section 14, both of which are prior part, takes place inside the NAS 1002, or to configurations in which a database management system program 213 is executed inside the NAS 1002.

The embodiments of the present invention have been described as embodiments that manage database operations to avoid conflicts between internal database operational management and database operational management based on instructions from outside; however, the present invention can also be applied to avoid conflicts between two database operational managements that both take place internally or between two database operational managements that are both based on instructions from outside.

This concludes detailed description of the present invention based on preferred embodiments, but the present invention is not limited to these and many modifications can be made without departing from the present invention.

According to the present invention, when an attempt is made to perform an additional database operational management from outside while an application that uses DBMS to manage data is performing a database operational management internally, a conflict can be avoided by adjusting the execution time of database operational management inside the DBMS, which allows a database operational management to be performed easily from outside by an application user.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A database operational management method for a database management system that performs a first database operational management according to instruction information concerning the first database operational management, the database operational management method comprising the steps of:
when a second database operational management additionally is performed, accepting instruction information concerning the second database operational management;
extracting information that includes a time range scheduled for executing the second database operational management;
extracting, from the instruction information concerning the first database operational management, operational management schedule information including a time range scheduled and a time range changeable for executing the first database operational management that is scheduled to be executed within the time range scheduled for executing the second database operational management; and
determining, based on the operational management schedule information extracted from the instruction information concerning the first database operational management, whether the time range scheduled for executing the first database operational management can be shifted outside the time range scheduled for executing the second database operational management.

2. A database operational management method according to claim 1, wherein, when the first database operational management that is scheduled to be executed in the time range scheduled for executing the second database operational management does not exist, the second database operational management is executed in the time range scheduled for executing the second database operational management.

3. A database operational management method according to claim 1, wherein, when the first database operational management that is scheduled to be executed in the time range scheduled for executing the second database operational management exists, and the time range scheduled for executing the first database operational management can be shifted outside the time range scheduled for executing the second database operational management, the time range scheduled for executing the first database operational management is shifted outside the time range scheduled for executing the second database operational management, and the second database operational management is executed in the time range scheduled for executing the second database operational management.

4. A database operational management method according to claim 1, wherein, when the first database operational management that is scheduled to be executed in the time range scheduled for executing the second database operational management exists, and the time range scheduled for executing the first database operational management can be shifted outside the time range scheduled for executing the second database operational management, a notification is issued as output information in response to instruction information concerning the second database operational management to change the time range scheduled for executing the second database operational management.

5. A database management system that performs a first database operational management according to instruction information concerning the first database operational management, comprising:
an operational management acceptance processing section that accepts information for a second database operational management instruction and extracts a time range scheduled for executing the second database operational management;
an operational management schedule information extraction processing section that extracts, from the instruction information concerning the first database operational management, operational management schedule information that includes the time range scheduled, as well as a time range changeable to, for executing the first database operational management;
an operational management time range shift determination processing section that, based on the operational management schedule information extracted from the instruction information concerning the first database operational management, determines whether the time range scheduled for executing the first database operational management can be shifted outside the time range scheduled for executing the second database operational management; and
an operational management time range change processing section that, when the first database operational management that is scheduled to be executed in the time range scheduled for executing the second database operational management exists, and the time range scheduled for executing the first database operational management can be shifted outside the time range scheduled for executing the second database operational management, shifts the time range scheduled for executing the first database operational management outside the time range scheduled for executing the second database operational management, and when the first database operational management that is scheduled to be executed in the time range scheduled for executing the second database operational management exists, and the time range scheduled for executing the first database operational management can be shifted outside the time range scheduled for executing the second database operational management, issues a notification as output information in response to the instruction information concerning the second database operational management to change the time range scheduled for executing the second database operational management.

6. A database operational management method for a database management system that performs a first database operational management according to first instruction information, the database operational management method comprising the steps of:
accepting second instruction information concerning a second database operational management different from the first database operational management;
extracting information concerning a first time range scheduled for executing the first database operational management;
extracting information including a second time range scheduled for executing the second database operational management;
determining if the first time range interferes with the second time range; and
determining whether the first time range can be shifted outside the second time range.

7. A database operational management method according to claim 6, wherein, when the first time range does not interfere with the second time range, the second database operational management is executed in the second time range.

8. A database operational management method according to claim 6, wherein, when the first time range interferes with the second time range, and the first time range can be shifted outside the second time range, the first time range is shifted outside the second time range, and the second database operational management is executed in the second time range.

9. A database operational management method according to claim 6, wherein, when the first time range interferes with the second time range, and the first time range can be shifted outside the second time range, a notification is issued as output information in response to the instruction information concerning the second database operational management to change the second time range scheduled for executing the second database operational management.

10. A database operational management system that performs a first database operational management according to first instruction information, the database operational management system comprising:
a section that accepts second instruction information concerning a second database operational management different from the first database operational management;
a section that extracts information concerning a first time range scheduled for executing the first database operational management;
a section that extracts information including a second time range scheduled for executing the second database operational management;
a section that determines if the first time range interferes with the second time range; and
a section that determines whether the first time range can be shifted outside the second time range.

11. A database operational management system according to claim 10, wherein, when the first time range does not interfere with the second time range, the second database operational management is executed in the second time range.

12. A database operational management system according to claim 10, wherein, when the first time range interferes with the second time range, and the first time range can be shifted outside the second time range, the first time range is shifted outside the second time range, and the second database operational management is executed in the second time range.

13. A database operational management system according to claim 10, wherein, when the first time range interferes with the second time range, and the first time range can be shifted outside the second time range, a notification is issued as output information in response to the instruction information concerning the second database operational management to change the second time range scheduled for executing the second database operational management.

14. A database operational management system that performs a first database operational management according to first instruction information concerning the first database operational management, comprising:
a module that accepts second instruction information for a second database operational management and extracts a time range scheduled for executing the second database operational management;
a module that extracts from the first instruction information operational management schedule information that includes a time range scheduled and a time range changeable for executing the first database operational management; and
a module that, based on the operational management schedule information extracted from the first instruction information, determines whether the time range scheduled for executing the first database operational management can be shifted outside the time range scheduled for executing the second database operational management.

15. A database operation management system according to claim 14, further comprising a time range changing module, when the first database operational management that is scheduled to be executed in a time range scheduled for executing the second database operational management does not exist, that executes the second database operational management in the time range scheduled for executing the second database operational management.

16. A database operational management system according to claim 14, wherein, when the first database operational management that is scheduled to be executed in a time range scheduled for executing the second database operational management exists, and the time range scheduled for executing the first database operational management can be shifted outside the time range scheduled for executing the second database operational management, the time range changing module shifts the time range scheduled for executing the first database operational management outside the time range scheduled for executing the second database operational management, and the second database operational management is executed in the time range scheduled for executing the second database operational management.

17. A database operational management system according to claim 14, wherein, when the first database operational management that is scheduled to be executed in the time range scheduled for executing the second database operational management exists, and the time range scheduled for executing the first database operational management can be shifted outside the time range scheduled for executing the second database operational management, the time range changing module issues a notification as output information in response to the second instruction information to change the time range scheduled for executing the second database operational management.

18. A database operational management program for a database management system that performs a first database operational management according to first instruction information, the database operational management program comprising:
accepting second instruction information concerning a second database operational management different from the first database operational management;
extracting information concerning a first time range scheduled for executing the first database operational management;
extracting information including a second time range scheduled for executing the second database operational management;
determining if the first time range interferes with the second time range; and
determining whether the first time range can be shifted outside the second time range.

19. A database operational management program according to claim 18, wherein, when the first time range does not interfere with the second time range, the second database operational management is executed in the second time range.

20. A database operational management program according to claim 18, wherein, when the first time range interferes with the second time range, and the first time range can be shifted outside the second time range, the first time range is shifted outside the second time range, and the second database operational management is executed in the second time range.

21. A database operational management program according to claim 18, wherein, when the first time range interferes with the second time range, and the first time range can be shifted outside the second time range, a notification is issued as output information in response to the instruction information concerning the second database operational management to change the second time range scheduled for executing the second database operational management.
